(19) United States
(12) Patent Application Publication
(10) Pub. No.: US 2026/0253903 A1
(43) Pub. Date: Aug. 27, 2026

(54) ELECTRODE CURRENT COLLECTOR

(71) Applicant: FORD GLOBAL TECHNOLOGIES, LLC, Dearborn, MI (US)

(72) Inventors: Minja SEO, Novi, MI (US); Gunho KWAK, Novi, MI (US); Ann Elizabeth O'NEILL, Dearborn, MI (US); Wenhui ZHU, Northville, MI (US)

(21) Appl. No.: 19/060,276

(22) Filed: Feb. 21, 2025

(51) Int. Cl. H01M 4/62; H01M 4/133; H01M 4/36; H01M 4/38; H01M 4/587; H01M 4/66; H01M 10/0525; H01M 10/0562; H01M 50/431; H01M 4/02

(52) U.S. Cl. CPC H01M 4/628; H01M 4/133; H01M 4/366; H01M 4/386; H01M 4/587; H01M 4/625; H01M 4/661; H01M 10/0525; H01M 10/0562; H01M 50/431; H01M 2004/021

(57) ABSTRACT

A solid-state lithium-ion battery component includes an electrode with a current collector and a silicon-based active layer. The active layer is made of silicon nanoparticles encapsulated within an interwoven carbon nanotube network. The carbon nanotube network is configured to maintain electrical connectivity and mechanically stabilize the silicon nanoparticles during volumetric expansion and contraction of the electrode throughout charge cycling.

### TECHNICAL FIELD

The disclosure relates to electrode materials for lithium-ion batteries.

### BACKGROUND

Silicon, due to its theoretically high lithium storage capacity and low potential of about 0.3 V versus Li⁺/Li, is a promising candidate for high-capacity anode material in solid-state batteries.

### SUMMARY

A solid-state lithium-ion battery component is provided. This component includes an electrode having a current collector and a silicon-based active layer adhered thereon. The silicon-based active layer includes silicon nanoparticles encapsulated within an interwoven carbon nanotube network configured to maintain electrical connectivity and mechanically stabilize the silicon nanoparticles during volumetric expansion and contraction of the electrode during charge cycling. The carbon nanotube network may contain single-walled carbon nanotubes, multi-walled carbon nanotubes, or a mixture thereof. The silicon nanoparticles may have a diameter in the range of 10 nm to 200 nm. The interwoven carbon nanotube network may reduce the volumetric expansion of the silicon nanoparticles to less than 300% during charge cycling. The electrode may further include a graphite-based active material layer adhered to the silicon-based active layer.

A solid-state battery is provided. This battery includes a separator and a pair of electrodes sandwiching the separator, at least one of the electrodes including a silicon-based active layer with silicon particles encapsulated and conductively interconnected by carbon nanotube chains that are configured to maintain conductive contact among the silicon particles in a lithiated state. The separator may be a sulfide-based solid electrolyte. The at least one electrode may further include a current collector. The current collector may be nickel-plated copper or stainless steel-based. The electrode may also include graphite and silicon active materials. The solid-state battery may have a specific capacity of 4200 milliampere-hours per gram.

A negative electrode assembly is provided. This assembly includes a current collector, a carbon nanotube scaffold forming an interwoven conductive network around encapsulated silicon nanoparticles, and an active material layer mechanically interlocked to the current collector via the carbon nanotube scaffold. The carbon nanotube scaffold may include single-walled and multi-walled carbon nanotubes. The active material layer may include a polymeric binder. The polymeric binder may be polyacrylic acid, carboxymethyl cellulose, styrene-butadiene rubber, or lithium polyacrylate. The active material layer may also include a conductive additive. The carbon additive may be carbon black, graphene, carbon nanotubes, vapor-grown carbon fibers, amorphous carbon coatings, metal nanowires, nickel nanoparticles, conductive polymers, carbon-coated metal nanoparticles, or graphene-carbon nanotube hybrids.

### BRIEF DESCRIPTION OF THE DRAWINGS

FIG. 1 is a schematic diagram of a silicon-based active layer;

FIG. 2 is a schematic diagram of a negative electrode assembly including the silicon-based active layer; and

FIG. 3 is a schematic diagram of a lithium-ion battery including the negative electrode assembly.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Unless explicitly stated otherwise, all numerical values and ranges related to quantities, measurements, percentages, weights, and similar numerical references in this disclosure should be interpreted as being preceded by the term “about.” This applies even when the term “about” is not expressly included. The intent is to encompass variations that may result from standard measurement tolerances, material properties, manufacturing processes, and the intended functionality of the disclosed battery components. For example, silicon nanoparticles described as having a diameter of “10 nm to 200 nm” should be understood as “about 10 nm to about 200 nm.” Similarly, when an interwoven carbon nanotube scaffold is stated to reduce the volumetric expansion of silicon nanoparticles to “less than 300%,” this should be interpreted as “about less than 300%.” Likewise, a solid-state battery described as having a specific capacity of “4200 milliampere-hours per gram” should be understood to mean “about 4200 milliampere-hours per gram.” Such variations are inherently included within the scope of this disclosure.

The term “positive electrode” refers to a battery cell electrode from which current flows out when the lithium-ion battery cell or battery is discharged. This electrode is sometimes referred to as a “cathode.”

The term “negative electrode” refers to a battery cell electrode to which current flows in when the lithium-ion battery cell is discharged. This electrode is sometimes referred to as an “anode.”

The term “electrochemical cell” or “battery cell” refers to a device including at least one positive electrode, at least one negative electrode, an electrolyte, and a separator membrane that allows ion transport while preventing electrical short circuits.

The term “battery” or “battery pack” refers to an electrical energy storage device including at least one electrochemical cell. In a refinement, a “battery” or “battery pack” includes multiple electrochemical cells electrically connected in series or parallel to achieve desired voltage and capacity characteristics.

The term “solid electrolyte” refers to an ionically conductive material that enables lithium-ion transport while preventing electron flow. Solid electrolytes may be sulfide-based, oxide-based, polymer-based, or composite materials.

The term “specific capacity” means the charge storage capacity per unit mass of an electrode active material. Specific capacity is measured in milliampere-hours per gram (mAh/g).

The term “carbon nanotube” refers to cylindrical nanostructures made of graphene sheets formed into seamless tubes. Carbon nanotubes may be single-walled carbon nanotubes or multi-walled carbon nanotubes.

The term “silicon nanoparticle” refers to a silicon-based material with particle sizes ranging from 10 nanometers (nm) to 200 nm.

The present disclosure relates to a negative electrode structure for sulfide-based all-solid-state batteries, addressing challenges associated with conventional silicon anodes and current collectors. Specifically, this disclosure describes a three-dimensional network of carbon nanotube-encapsulated silicon nanoparticles coated on a corrosion-resistant anode current collector. By replacing the traditional copper current collector with nickel-plated copper or stainless steel, the proposed arrangements mitigate the oxidation issues that arise from interactions with sulfide electrolytes. Additionally, the carbon nanotube-encapsulated silicon nanoparticles increase electrical conductivity, structural stability, and suppress volumetric expansion of silicon during charge and discharge cycles.

Silicon may experience volume expansion of up to 300% during cycling, which may cause weak adhesion to current collectors. This may contribute to rapid capacity fading and mechanical degradation. Existing solutions, such as mixing carbon nanotubes into the electrode material do not address interfacial instability. The disclosed approach overcomes these limitations by forming a three-dimensional carbon nanotube network encapsulating silicon nanoparticles directly on the current collector, providing a continuous conductive path and structural reinforcement that increases electrochemical performance.

Silicon nanoparticles provide advantages over larger silicon particles due to their higher surface area-to-volume ratio, which facilitates faster lithium-ion diffusion and increased reaction kinetics. However, this increased surface area also makes silicon nanoparticles more prone to aggregation and unstable solid electrolyte interphase formation. To mitigate these effects, the disclosed carbon nanotube scaffold stabilizes the nanoparticles, preventing their agglomeration and reducing side reactions with sulfide electrolytes. The encapsulated silicon nanoparticles exhibit increased cycling stability, maintaining structural integrity over extended charge-discharge cycles.

The size of the silicon nanoparticles influences anode performance. Smaller nanoparticles, which may be in the range of 10 nm to 50 nm, have less pronounced volumetric expansion compared to larger nanoparticles, which may exceed 100 nm. Additionally, smaller nanoparticles facilitate uniform lithium-ion distribution within an electrode, minimizing localized accumulation of forces that may lead to mechanical fracture.

Carbon nanotubes are utilized as an electrode material component due to their electrical conductivity, mechanical strength, and flexibility. Carbon nanotubes may be categorized as single-walled carbon nanotubes and multi-walled carbon nanotubes, both of which contribute to increased battery performance. Single-walled carbon nanotubes provide increased electrical conductivity due to their minimal structural defects, while multi-walled carbon nanotubes provide increased mechanical reinforcement, increasing electrode durability.

In addition to their mechanical and electrical properties, carbon nanotubes form an interconnected conductive network that facilitates electron transport throughout an electrode. This interconnected network maintains continuous contact between the silicon nanoparticles and the current collector, reducing resistance and increasing rate capability. Carbon nanotubes also suppress excessive volume expansion of silicon nanoparticles via structural confinement, reducing force accumulation that may lead to material degradation.

To further increase the stability of the anode current collector in sulfide-based electrolytes, this disclosure also introduces the use of nickel-plated copper and stainless steel as alternative materials. Conventional copper current collectors may experience side reactions with sulfide electrolytes, leading to oxidation and degradation over time. The incorporation of nickel plating or stainless steel provides a chemically stable and electrochemically compatible interface.

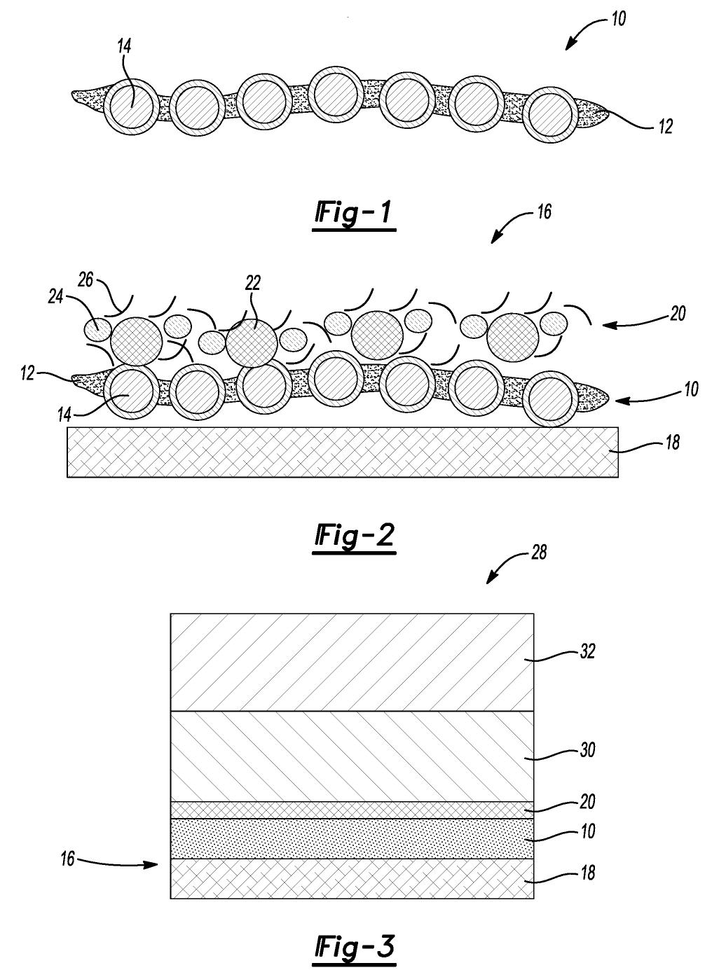

FIG. 1 is a silicon-based active layer 10 incorporating a carbon nanotube scaffold 12 that encapsulates silicon nanoparticles 14. The carbon nanotube scaffold 12 is made of an interwoven network of carbon nanotubes, which may include single-walled carbon nanotubes, multi-walled carbon nanotubes, or a combination of both. The carbon nanotube scaffold 12 serves as a conductive matrix that provides electron transport pathways. The carbon nanotube scaffold 12 also mechanically stabilizes the silicon nanoparticles 14, mitigating the effects of volume expansion and contraction that occur during lithiation and de-lithiation cycles. The carbon nanotube scaffold 12 is configured to reduce the volumetric expansion of the silicon nanoparticles 14 to less than 300% during charge cycling. The silicon nanoparticles 14 are encapsulated within the carbon nanotube scaffold 12, maintaining continuous electrical connectivity. The size of the silicon nanoparticles 14 may range from 10 nm to 200 nm.

FIG. 2 shows a negative electrode assembly 16 incorporating the silicon-based active layer 10 with the carbon nanotube scaffold 12 encapsulating the silicon nanoparticles 14, adhered on a current collector 18 and laminated with an active material layer 20. The carbon nanotube scaffold 12 in the silicon-based active layer 10 interlocks with the active material layer 20 and mechanically interlocks with the current collector 18. The current collector 18 provides structural support and facilitates electron transport. The current collector 18 may be made of a nickel-plated copper or stainless steel-based materials for oxidation resistance.

Positioned above the silicon-based active layer 10, the active material layer 20 includes active material particles 22, conductive additives 24, and a polymeric binder 26. The active material particles 22 contribute to lithium-ion storage and may be silicon, graphite, or a composite of both materials. Conductive additives 24, such as vapor-grown carbon fibers, amorphous carbon coatings, metal nanowires, nickel nanoparticles, conductive polymers, carbon-coated metal nanoparticles, and graphene-carbon nanotube hybrids, may increase electron transport within the negative electrode assembly 16. The polymeric binder 26, which may be polyacrylic acid, carboxymethyl cellulose, styrene-butadiene rubber, or lithium polyacrylate, secures the active material particles 22 and conductive additives 24 within the negative electrode assembly 16, to maintain mechanical cohesion. The encapsulation by the carbon nanotube scaffold 12 prevents the silicon nanoparticles 14 from losing contact with the current collector 18 due to charge cycling related expansion.

FIG. 3 shows a lithium-ion battery 28 incorporating the negative electrode assembly 16, a separator 30, and a positive electrode 32. The negative electrode assembly 16 includes the silicon-based active layer 10 positioned on the current collector 18 and the active material layer 20. The separator 30 is positioned between the negative electrode assembly 16 and the positive electrode 32 to prevent electrical short circuits while allowing lithium-ion transport through the lithium-ion battery 28. The separator 30 may be a sulfide-based solid electrolyte, which facilitates ion conduction. The solid-state nature of the separator 30 eliminates the need for liquid electrolytes. The positive electrode 32 may include lithium transition metal oxides or other high-capacity cathode materials. The lithium-ion battery 28 is configured to achieve a specific capacity of 4200 mAh/g.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A solid-state lithium-ion battery component comprising:
an electrode having a current collector and a silicon-based active layer adhered on the current collector that includes silicon nanoparticles encapsulated within an interwoven carbon nanotube network configured to maintain electrical connectivity and mechanically stabilize the silicon nanoparticles during volumetric expansion and contraction of the electrode during charge cycling.

2. The solid-state lithium-ion battery component of claim 1 wherein the carbon nanotube network contains single-walled carbon nanotubes.

3. The solid-state lithium-ion battery component of claim 1 wherein the carbon nanotube network contains multi-walled carbon nanotubes.

4. The solid-state lithium-ion battery component of claim 1 wherein the carbon nanotube network contains a mixture of single-walled and multi-walled carbon nanotubes.

5. The solid-state lithium-ion battery component of claim 1 wherein the silicon nanoparticles have a diameter in a range of 10 nm to 200 nm.

6. The solid-state lithium-ion battery component of claim 1 wherein the interwoven carbon nanotube network reduces the volumetric expansion of the silicon nanoparticles to less than 300% during charge cycling.

7. The solid-state lithium-ion battery component of claim 1, further comprising a graphite-based active material layer adhered to the silicon-based active layer.

8. A solid-state battery comprising:
a separator; and
a pair of electrodes sandwiching the separator, at least one of the electrodes including a silicon-based active layer with silicon particles encapsulated and conductively interconnected by carbon nanotube chains that are configured to maintain conductive contact among the silicon particles in a lithiated state.

9. The solid-state battery of claim 8 wherein the separator is a sulfide-based solid electrolyte.

10. The solid-state battery of claim 8 wherein the at least one electrode further includes a current collector.

11. The solid-state battery of claim 10 wherein the current collector is nickel-plated copper.

12. The solid-state battery of claim 10 wherein the current collector is stainless steel-based.

13. The solid-state battery of claim 8 wherein the at least one electrode includes graphite and silicon active materials.

14. The solid-state battery of claim 8 wherein the solid-state battery has a specific capacity of 4200 milliampere-hours per gram.

15. A negative electrode assembly comprising:
a current collector;
a carbon nanotube scaffold, forming an interwoven conductive network around encapsulated silicon nanoparticles, laminated onto the current collector; and
an active material layer mechanically interlocked to the current collector via the carbon nanotube scaffold.

16. The negative electrode assembly of claim 15 wherein the carbon nanotube scaffold includes single-walled and multi-walled carbon nanotubes.

17. The negative electrode assembly of claim 15 wherein the active material layer includes a polymeric binder.

18. The negative electrode assembly of claim 17 wherein the polymeric binder is selected from the group consisting of polyacrylic acid, carboxymethyl cellulose, styrene-butadiene rubber, and lithium polyacrylate.

19. The negative electrode assembly of claim 15 wherein the active material layer includes a conductive additive.

20. The negative electrode assembly of claim 19 wherein the conductive additive is selected from the group consisting of carbon black, graphene, carbon nanotubes, vapor-grown carbon fibers, amorphous carbon coatings, metal nanowires, nickel nanoparticles, conductive polymers, carbon-coated metal nanoparticles, and graphene carbon nanotube hybrids.
